(19) United States
(12) Patent Application Publication
(10) Pub. No.: US 2026/0099940 A1
(43) Pub. Date: Apr. 9, 2026

(54) METHOD FOR TRAINING KEY POINT DETECTION MODEL, METHOD FOR DRIVING VIRTUAL CHARACTER, ELECTRONIC DEVICE, STORAGE MEDIUM, AND COMPUTER PROGRAM PRODUCT

(71) Applicant: BIGO TECHNOLOGY PTE. LTD., Mapletree Business City (SG)

(72) Inventors: Bo DENG, Guangzhou (CN); Jiazhou WANG, Guangzhou (CN)

(21) Appl. No.: 19/110,589

(22) PCT Filed: Sep. 4, 2023
(86) PCT No.: PCT/CN2023/116711

§ 371 Date: Mar. 11, 2025

(30) Foreign Application Priority Data
Sep. 20, 2022 (CN) 202211145707.2

(51) Int. Cl. G06T 7/73; G06T 5/60; G06T 5/70; G06T 7/55

(52) U.S. Cl. CPC G06T 7/73; G06T 5/60; G06T 5/70; G06T 7/55; G06T 2207/10024; G06T 2207/20076; G06T 2207/20081; G06T 2207/20084; G06T 2207/30196; G06T 2210/22

(57) ABSTRACT

A method for driving a virtual character includes: acquiring a target image frame, the target image frame comprising an image of a part of a human body; inputting the target image frame into a pre-trained key point detection model, and acquiring coordinate information and a field-of-view probability of a human body key point of the target image frame output by the key point detection model, the field-of-view probability being a probability that the human body key point appears within an imaging field of view of the target image frame; and driving, based on the coordinate information and the field-of-view probability of the human body key point, a corresponding virtual character to act.

The application claims priority to Chinese Patent Application No. 202211145707.2, filed with China National Intellectual Property Administration on Sep. 20, 2022, the disclosure of which is herein incorporated by reference in its entirety.

### TECHNICAL FIELD

The present disclosure relates to the field of image processing technologies, and in particular, to a method for training a key point detection model, a method for driving a virtual character, an apparatus for training a key point detection model, an apparatus for driving a virtual character, an electronic device, a computer-readable storage medium, and a computer program product.

### BACKGROUND

With the development of the virtual industry, a digital live broadcast form has emerged in the field of live streaming, such as a virtual anchor presented entirely by a virtual character.

In some related arts, the virtual anchor is achieved by adopting technologies such as optical motion capture and inertial motion capture. However, the implementation of these technologies requires the anchor to wear professional equipment for a long time, and a variety of cables usually need to be connected to the professional equipment, which result in a poor live streaming experience.

In some other related art, 3D human body data in a real environment is generated based on end-to-end 3D (three dimensions) pose data. The end-to-end 3D pose estimation method can greatly enhance the interaction capability of the virtual character. To acquire 3D human body data, the related art uses a deep learning network to predict the human body 3D joint points from the input RGB video acquired by a common RGB camera. This solution generally performs image processing on the entire human body, and the camera usually needs a wider field of view (FOV) and a better shooting angle, for example, the field of view needs to cover most of the human body. In the case that the user is close to the camera and only some parts of the human body are present, error detection of the posture points likely occurs due to the limited terminal performance, small field of view, and the fact that the hands/elbows or other parts of the human body possibly move out of the field of view frequently, and so on. Moreover, due to the limited resources of the mobile terminal, many heatmap-based methods cannot achieve enough coordinate accuracy due to the resolution limitation, and the stability of the output coordinates is also greatly affected.

### SUMMARY

The present disclosure provides a method for training a key point detection model, a method for driving a virtual character, an apparatus for training a key point detection model, and an apparatus for driving a virtual character, to solve the problems of the related art that error detection of the posture points likely occurs and the stability of output coordinates is poor.

The present disclosure provides a method for driving a virtual character. The method includes: acquiring a target image frame, the target image frame including an image of a part of a human body; inputting the target image frame into a pre-trained key point detection model, and acquiring coordinate information and a field-of-view probability of a human body key point of the target image frame output by the key point detection model, the field-of-view probability being a probability that the human body key point appears within an imaging field of view of the target image frame; and driving, based on the coordinate information and the field-of-view probability of the human body key point, a corresponding virtual character to act.

The present disclosure provides a method for training a key point detection model. The method includes: determining coordinate information of a plurality of key points in each sample image frame of a plurality of sample image frames in a sample set by performing key point detection on the plurality of sample image frames; determining a field-of-view label of each key point of the plurality of key points based on coordinate information of the key point, the field-of-view label being configured to mark whether the key point is within the imaging field of view of a sample image frame to which the key point belongs; and training the key point detection model by taking coordinate information and field-of-view labels of a plurality of key points of the plurality of sample image frames as a supervision signal, the key point detection model being configured to perform key point detection on a target image frame in a model inference stage and output coordinate information and a field-of-view probability of a key point in the target image frame.

The present disclosure provides an apparatus for driving a virtual character. The apparatus includes: an image acquiring module, configured to acquire a target image frame, the target image frame including an image of a part of a human body; a human body key point detecting module, configured to input the target image frame into a pre-trained key point detection model, and acquire coordinate information and a field-of-view probability of a human body key point of the target image frame output by the key point detection model, the field-of-view probability being a probability that the human body key point appears within an imaging field of view of the target image frame; and a virtual character driving module, configured to drive a corresponding virtual character to act based on the coordinate information and the field-of-view probability of the human body key point.

The present disclosure provides an apparatus for training a key point detection model. The apparatus includes: a key point detecting module, configured to determine coordinate information of a plurality of key points in each sample image frame of a plurality of sample image frames in a sample set by performing key point detection on the plurality of sample image frames; a field-of-view label determining module, configured to determine a field-of-view label of each key point of the plurality of key points based on coordinate information of the key point, the field-of-view label being configured to mark whether the key point is within the imaging field of view of a sample image frame to which the key point belongs; and a model training module, configured to train the key point detection model by taking coordinate information and field-of-view labels of a plurality of key points of the plurality of sample image frames as a supervision signal, the key point detection model being configured to perform key point detection on a target image frame in a model inference stage and output coordinate information and a field-of-view probability of a key point in the target image frame.

The present disclosure provides an electronic device. The electronic device includes: one or more processors; and a storage device communicatively connected to the one or more processors; wherein the storage device stores one or more computer programs executable by the one or more processors. The one or more computer programs, when loaded and run by the one or more processors, cause the one or more processors to perform the above-described method for driving a virtual character or the above-described method for training a key point detection model.

According to a sixth aspect of the present disclosure, a computer-readable storage medium is provided. The computer-readable storage medium stores one or more computer instructions, wherein the one or more computer instructions, when run by a processor, cause the processor to perform the above-described method for training a key point detection model or method for training a key point detection model.

According to a seventh aspect of the present disclosure, a computer program product is provided. The computer program product includes one or more computer-executable instructions, wherein the one or more computer-executable instructions, when run by a processor of a device, cause the device to perform the above-described method for training a key point detection model or method for training a key point detection model.

### BRIEF DESCRIPTION OF DRAWINGS

The following briefly introduces the accompanying drawings required for describing the embodiments.

FIG. 1 is a flowchart of a method for training a key point detection model according to embodiment 1 of the present disclosure;

FIG. 2 is a schematic diagram of a sample image frame according to embodiment 1 of the present disclosure;

FIG. 3 is a schematic diagram of a cropped sample image frame according to embodiment 1 of the present disclosure;

FIG. 4 is a flowchart of a method for driving a virtual character according to embodiment 2 of the present disclosure;

FIG. 5 is a structural schematic diagram of an apparatus for training a key point detection model according to embodiment 3 of the present disclosure;

FIG. 6 is a structural schematic diagram of an apparatus for driving a virtual character according to embodiment 4 of the present disclosure; and

FIG. 7 is a structural schematic diagram of an electronic device according to embodiment 5 of the present disclosure.

### DETAILED DESCRIPTION

The technical solutions in the embodiments of the present disclosure are described hereinafter with reference to the accompanying drawings in the embodiments of the present disclosure, and the described embodiments are only some embodiments of the present disclosure. Based on the embodiments of the present disclosure, all other embodiments acquired by a person of ordinary skill in the art without making creative labor shall fall within the scope of protection of the present disclosure.

It should be noted that the terms “first,” “second”, etc. in the specification and claims of the present disclosure and the above-described drawings are used to differentiate between similar objects, rather than describing a particular order or sequence. It should be understood that the data so used may be interchanged in some appropriate cases, such that the embodiments of the present disclosure described herein can be implemented in an order other than those illustrated or described herein. In addition, the terms “comprising,” “having”, and any variations thereof are intended to express non-exclusively comprising, e.g., a process, method, system, product, or apparatus including a series of processes or units is not limited to those listed processes or units, but includes other processes or units that are not listed or that are inherent to the process, method, product, or apparatus.

### Embodiment 1

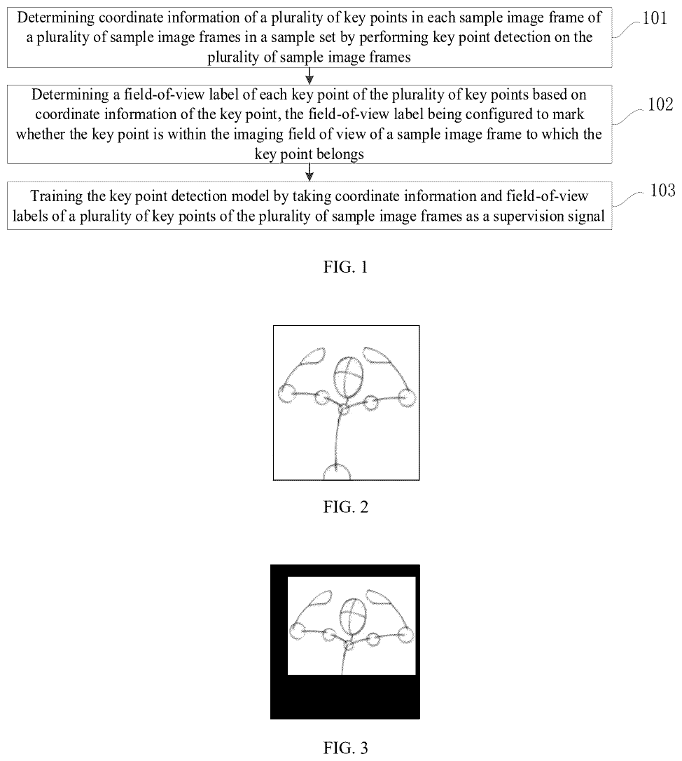

FIG. 1 is a flowchart of a method for training a key point detection model according to embodiment 1 of the present disclosure. The key point detection model is configured to detect a human key point in an image (e.g., a half-body image) with features of a part of the human body, and is applicable to detection scenarios of human body key points. In some embodiments, the key point detection model is used in live broadcasting scenarios, and a virtual character is driven to act by detecting a human key point.

In virtual live broadcasting scenarios, the end-to-end 3D pose estimation method can greatly enhance the interaction capability of virtual anchors. According to research and analysis, it is found that virtual anchors commonly use cell phones for live broadcasting. This scene has characteristics of limited terminal performance, small field of view, the hand/elbow and other parts of the human body likely move out of the field of view frequently, etc., Under this scene, many open-source 3D posture point detection schemes are also with a high error rate. The field of view is the maximum range that the camera of the terminal is able to observe, and the larger the field of view, the larger the observation range.

The present embodiment designs a low-cost model training method for training a key point detection model based on a common RGB camera without increasing the cost of additional shooting hardware and usage of the anchor, wherein the key point detection model is a neural network model in some embodiments. In some embodiments, the key point detection model includes two prediction heads, each of which is equivalent to a layer of a neural network. The inputs of the two prediction heads are feature maps, wherein one of the prediction heads is configured to predict the position of the key point based on the feature map, and the other prediction head is configured to make a prediction, based on the feature map, that whether or not the key point is within the field of view. Therefore, it can be determined whether the key point is within the field of view through the key point detection model, which improves the key point detection accuracy of the key point detection model for images acquired from the near-field scene.

As shown in FIG. 1, the embodiment includes the following processes.

In process 101, coordinate information of a plurality of key points in each sample image frame of a plurality of sample image frames in a sample set is determined by performing key point detection on the plurality of sample image frames.

In some embodiments, the sample image frame includes main human body postures, which enables higher accuracy of the prediction results of the posture network.

In some embodiments, the key point detection of the sample image frame is performed through a pre-generated posture detection model, wherein the posture detection model is a two-dimensional posture detection model or a three-dimensional posture detection model. In some embodiments, to improve the accuracy of the detection, the posture detection model is a model acquired by combining the two-dimensional posture detection model with the three-dimensional posture detection model.

In some embodiments, the key points are different depending on the business requirements, which is not limited in the embodiments of the present disclosure. In some embodiments, the key points include but are not limited to: a left shoulder point, a right shoulder point, a left elbow point, a right elbow point, a left wrist point, a right wrist point, a left palm point, a right palm point, a hip joint point, a nose point, or the like.

In some embodiments, the coordinate information of the key points is represented using image coordinates and depth information. In some implementations, the depth information is acquired using a predetermined depth information calculation algorithm without adding additional depth sensors to acquire the depth information, thereby saving hardware costs and calibration costs.

In some embodiments, process 101 includes the following processes.

In process 101-1, the plurality of sample image frames are input into a pre-generated two-dimensional posture network, and two-dimensional coordinate information of key points of the plurality of sample image frames is acquired from the two-dimensional posture network.

In some embodiments, the two-dimensional coordinate information is coordinate information under an image coordinate system, including a horizontal coordinate value and a vertical coordinate value, and is expressed as

$${P}_{2 d}^{n} = ( {u}_{n} , {v}_{n} ) ,$$

wherein

$${P}_{2 d}^{n}$$

represent the two-dimensional coordinate information of the key point numbered n of the sample image frame, uₙ represents the horizontal coordinate value of the key point numbered n of the sample image frame, and vₙ represents the vertical coordinate value of the key point numbered n of the sample image frame.

$${P}_{2 d}^{n} ∈ {R}^{n \times 2} ,$$

wherein R^{n×2} represents a n×2 dimensional set of real numbers, i.e., each element of

$${P}_{2 d}^{1} , {P}_{2 d}^{2} , … , {P}_{2 d}^{n}$$

is a two dimensional vector, and each component of the vector is a real number.

In process 101-2, the plurality of sample image frames are input into a pre-generated three-dimensional posture network, and three-dimensional coordinate information of the key points of the plurality of sample image frames is acquired from the three-dimensional posture network.

In some embodiments, the three-dimensional coordinate information is coordinate information under a world coordinate system, including an X-axis coordinate value, a Y-axis coordinate value, and a Z-axis coordinate value, and is expressed as

$${P}_{3 d}^{n} = ( {x}_{n} , {y}_{n} , {z}_{n} ) ,$$

wherein P_{3d}ⁿ represents the three-dimensional coordinate information of the key point numbered n of the sample image frame, xₙ represents the X-axis coordinate value of the key point numbered n of the sample image frame, yₙ represents the Y-axis coordinate value of the key point numbered n of the sample image frame, zₙ represents the Z-axis coordinate value of the key point numbered n of the sample image frame.

$${P}_{3 d}^{n} ∈ {R}^{n \times 3} ,$$

wherein R^{n×3} represents a n×3 dimensional set of real numbers, i.e., each element of

$${P}_{3 d}^{1} , {P}_{3 d}^{2} , … , {P}_{3 d}^{n}$$

is a three-dimensional vector, and each component of the vector is a real number.

It is to be noted that both the two-dimensional posture network and the three-dimensional posture network are existing posture network models in some embodiments. The present embodiment assumes that the key points detected by the two networks are the same, only that the coordinate system scales of the key points of the two networks are inconsonant. Therefore, the coordinate data needs to be unified as described in process 101-3.

In process 101-3, coordinate information of each of the key points is determined based on the acquired two-dimensional coordinate information and the three-dimensional coordinate information of the key points.

In this process, the coordinate information of each key point is the coordinate information acquired by fusing the two-dimensional coordinate information and the three-dimensional coordinate information of the key point in some embodiments, thereby achieving the transformation of the different outputs of the two-dimensional posture network and the three-dimensional posture network into a unified coordinate system. In some embodiments, the coordinate information includes depth information, which is calculated based on the two-dimensional coordinate information and the three-dimensional coordinate information.

In some embodiments, process 101-3 includes the following processes.

In process 101-3-1, a first stable key point and a second stable key point are determined from the plurality of key points of the plurality of sample image frames.

In practice, the stable key point is a key point that stably exists in the field of view, such as shoulder points, elbow points, nose points, or the like.

In some embodiments, the first stable key point and the second stable key point are in the form of key point pairs, e.g., the first stable key point is a left shoulder point and the second stable key point is a right shoulder point; or, the first stable key point is a left elbow point and the second stable key point is a right elbow point, and so on.

In some implementations, a developer pre-configures a whitelist of stable key points for different application scenarios. In the case that the first stable key point and the second stable key point need to be determined, the whitelist of stable key points under the corresponding scenario is acquired based on the current application scenario (e.g., a live broadcasting scenario); and a plurality of current detected key points are matched with the whitelist of stable key points, and then the matched key points are determined as stable key points.

The first stable key point and the second stable key point are not limited to any specific order, but are only used to distinguish different stable key points. In the case that a pair of stable key points are found, one of the stable key points is determined as the first stable key point, and the other of the stable key points is determined as the second stable key point.

In process 101-3-2, an adjustment coefficient is determined based on two-dimensional coordinate information and three-dimensional coordinate information of the first stable key point and two-dimensional coordinate information and three-dimensional coordinate information of the second stable key point.

The adjustment coefficient is a parameter reflecting the scale difference of the coordinate systems of the two-dimensional coordinate information and the three-dimensional coordinate information, and the depth information of the plurality of key points is determined based on the adjustment coefficient in some embodiments.

In some embodiments, process 101-3-2 includes the following processes.

An absolute value of a difference between the two-dimensional coordinate information of the first stable key point and the two-dimensional coordinate information of the second stable key point is determined as a first difference; an absolute value of a difference between the three-dimensional coordinate information of the first stable key point and the three-dimensional coordinate information of the second stable key point is determined as a second difference; and a ratio of the first difference to the second difference is determined as the adjustment coefficient.

In some embodiments, assuming that the first stable key point is a left shoulder point with a key point number of 0 and the second stable key point is a right shoulder point with a key point number of 1, then there are the following:

$$first difference = ‖ {P}_{2 d}^{0} - {P}_{2 d}^{1} ‖ ;$$

$$second difference = ‖ {P}_{3 d}^{0} - {P}_{3 d}^{1} ‖ ;$$

$$and$$

$$adjustment coefficient scale = \frac{‖ {P}_{2 d}^{0} - {P}_{2 d}^{1} ‖}{‖ {P}_{3 d}^{0} - {P}_{3 d}^{1} ‖} .$$

In process 101-3-3, a depth value of each of the key points is acquired by adjusting, using the adjustment coefficient, Z-axis coordinate values of the plurality of key points of the plurality of sample image frames.

In some implementations, the depth value depth of each key point is expressed as:

$${depth}_{n} = scale * {z}_{n} .$$

In process 101-3-4, a horizontal coordinate value, a vertical coordinate value, and the depth value of each of the key points are determined as coordinate information of the key point.

In the case that the depth value of each key point is acquired, the image coordinates and depth value of each key point are organized into the final coordinate information of the key point, i.e.,

$${J}_{3 d}^{n} = ( {u}_{n} , {v}_{n} , {depth}_{n} ) ,$$

wherein

$${J}_{3 d}^{n} ∈ {R}^{n \times 3} .$$

In the present embodiment, two-dimensional coordinate information of the key points of the sample image frames is acquired using the two-dimensional posture network, three-dimensional coordinate information of the key points of the sample image frames is acquired using the three-dimensional posture network, and then the final coordinate information of each key point is acquired by fusing the two-dimensional coordinate information and the three-dimensional coordinate information. In this way, coordinate information of key points with higher accuracy and stability is acquired with lower costs, and the detection accuracy of the key points is improved.

In some embodiments, upon determining the coordinate information of the plurality of key points in each sample image frame of the sample image frames, the method further includes performing image augmentation on the plurality of sample image frames based on the coordinate information of the plurality of key points in each sample image frame, wherein the image augmentation includes at least one of: random perturbation, cropping, or the combination thereof.

The implementation manner of the random perturbation is not limited in the present embodiment. In some embodiments, the random perturbation refers to randomly varying the pixel values of each pixel point in a predetermined manner. Then, in some embodiments, in the case that the predetermined manner is to randomly perturb in a perturbation range of [−20,20] relative to the original value, assuming that pixel RGB values of a pixels point are (6, 12, 230), the pixel RGB values of a pixels point becomes (8, 12, 226) upon random perturbation in a predetermined manner. The range of each color in the pixel value is [0,255], i.e., the maximum value is 255 and the minimum value is 0 upon perturbation.

To simulate a near-field scene in which an object is close to the shooting device, the cropping is performed on the plurality of sample image frames (including sample image frames generated upon random perturbation). In some embodiments, the cropping includes the following process:
determining a center position of a cropping frame based on the coordinate information of the plurality of key points in each sample image frame; and determining a cropping frame position based on the center position of the cropping frame, and setting, based on the cropping frame position, RGB values of a pixel point outside the cropping frame to make the pixel point black.

In some implementations, the center position of the cropping frame is the center position of the human body in the sample image frame, and the center position of the cropping frame is calculated based on the coordinate information of the detected key point. In some embodiments, the center position of the cropping frame is the average of the coordinate information of the three points of the left shoulder point, the right shoulder point, and the hip joint point.

Upon acquiring the center position of the cropping frame, the position of the cropping frame is determined based on the center position of the cropping frame and the predetermined size of the cropping frame (i.e., the width and height of the cropping frame). Upon determining the position of the cropping frame, the RGB values of the pixels outside the cropping frame are set to make the pixels black (i.e., the RGB values are 0) to acquire the cropped sample image frame. In some embodiments, the sample image frame is shown in FIG. 2, and then the cropped sample image frame is shown in FIG. 3.

In some embodiments, random perturbation is performed for the size of the cropping frame to acquire cropped sample image frames with different cropping frame sizes.

In the embodiments, the image augmentation enlarges the training dataset, suppresses model overfitting, and improves model generalization ability. At the same time, effective simulation of the target scene is achieved by a low-cost annotation transfer method and a data preprocessing method.

In process 102, a field-of-view label of each key point of the plurality of key points is determined based on coordinate information of the key point, the field-of-view label being configured to mark whether the key point is within the imaging field of view of a sample image frame to which the key point belongs.

Upon a set of key points of a plurality of sample image frames being detected, it is possible that a detected key point is not within the field of view of the sample image frame due to the limited accuracy of the model detection, for instance, the palm point is not in the image of the sample image frame, but the detected key points include the palm point. Regarding the above problem, in some embodiments, for each key point, it is determined, based on the coordinate information of the key point, whether the key point is within the imaging field of view of the sample image frame to which the key point belongs, so as to determine the field-of-view label of the key point. In some embodiments, in the case that a key point is within the imaging field of view of the sample image frame to which the key point belongs, the field-of-view label of the key point is 1; and in the case that a key point is not within the imaging field of view of the sample image frame to which the key point belongs, the field-of-view label of the key point is 0.

In some embodiments, the size of the sample image frame is compared with the coordinate information of the key point to determine whether the key point is within the imaging field of view of the sample image frame to which the key point belongs; and in the case that it is determined based on the coordinate information of the key point that the key point is within the range of the sample image frame to which the key point belongs, the key point is determined to be within the imaging field of view, and in the case that it is determined based on the coordinate information of the key point that the key point is not within the range of the sample image frame to which the key point belongs, the key point is determined to be outside the imaging field of view.

In some embodiments, process 102 includes the following processes.

A width and a height of each sample image frame are acquired; by taking an origin of an image coordinate system as a starting point, a horizontal coordinate range is determined based on widths of the plurality of sample image frames, and a vertical coordinate range is determined based on heights of the plurality of sample image frames; in response to a horizontal coordinate value of a key point being within the horizontal coordinate range, or, a vertical coordinate value of the key point being within the vertical coordinate range, the field-of-view label of the key point is determined to be an in-field-of-view label; and in response to the horizontal coordinate value of a key point being out of the horizontal coordinate range and the vertical coordinate value of the key point being out of the vertical coordinate range, the field-of-view label of the key point is determined to be an out-of-field-of-view label.

In some embodiments, the origin of the image coordinate system is taken as the starting point, the width of the sample image frame is taken as the length of the horizontal coordinate axis, that is, the horizontal coordinate range is [0, width], with width represents a width; and the height of the sample image frame is taken as the length of the vertical coordinate axis, that is, the vertical coordinate range is [0, height], with height represents a height.

In some embodiments, the field-of-view label is determined based on the following logical judgment equation:

$${L}_{n} = \{ \begin{matrix}1 , & {u}_{n} < 0 ‖ {u}_{n} > width ‖ {v}_{n} < 0 ‖ {v}_{n} > height \\ 0 , & other\end{matrix} .$$

In process 103, the key point detection model is trained by taking coordinate information and field-of-view labels of a plurality of key points of the plurality of sample image frames as a supervision signal.

In this process, the coordinate information and the field-of-view labels of the plurality of key points of the plurality of sample image frames acquired are used as a supervision signal to train the key point detection model.

The key point detection model is configured to perform key point detection on the target image frame in the model inference stage and output the coordinate information and the field-of-view probabilities of the key points of the target image frame. In some embodiments, in subsequent applications, the coordinate information and the field-of-view probabilities are used to drive the corresponding virtual character to act.

In some embodiments, when training the key point detection model, the loss function used includes a heatmap loss function Lossₕₑₐₜₘₐₚ, a location loss function Loss_{location}, and a label loss function Loss_{label}, and in some embodiments:

$${Loss}_{total} = {Loss}_{heatmap} + {Loss}_{location} + {Loss}_{label} .$$

It should be noted that the embodiments do not limit the implementation of the above three loss functions. In some embodiments, Lossₕₑₐₜₘₐₚ is implemented with L2 loss, Loss_{location} is implemented with L1 loss, and Loss_{label} is implemented with cross-entropy loss.

In the embodiments, in the data preparation stage, coordinate information and field-of-view labels of a plurality of key points in each sample image frame of the plurality of sample image frames are acquired, wherein the field-of-view label is configured to mark whether or not the key point is within the imaging field of view of the sample image frame to which the key point belongs; and in the model training stage, the coordinate information and the field-of-view labels of the plurality of key points of the plurality of sample image frames are used as a supervision signal to train a key point detection model. The key point detection model, by introducing an additional prediction header, is capable of outputting the field-of-view labels of the key points, such that whether the key point is in the field of view is effectively determined, and the key point detection accuracy of the key point detection model for images in a near-field scene is improved. Specifically, in the case that the user is close to the camera, and only a part of the human body is present in the camera's imaging field of view, the key point detection model of the embodiments is capable of outputting field-of-view labels indicating whether a plurality of key points of the human body are in the field of view or outside the field of view, so as to avoid the cases in which the key points outside the field of view is subsequently used for scene processing, which affects the processing effect.

### Embodiment 2

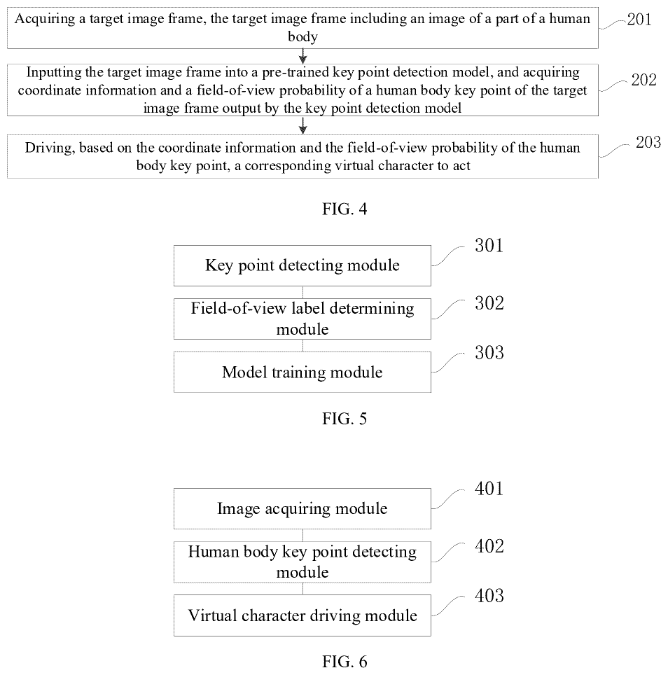

FIG. 4 is a flowchart of a method for driving a virtual character according to embodiment 2 of the present disclosure. The present embodiment is the model inference stage of the key point detection model of embodiment 1. The present embodiment

As shown in FIG. 4, the present embodiment includes the following processes.

In process 201, a target image frame is acquired, the target image frame including an image of a part of a human body.

In some embodiments, the target image frame is an image frame captured in real time, such as, a half-body photo of an anchor captured by a device such as a cell phone in a live broadcasting scenario.

In process 202, the target image frame is input into a pre-trained key point detection model, and coordinate information and a field-of-view probability of a human body key point of the target image frame output by the key point detection model are acquired.

In the case that the target image frame is acquired, the target image frame is input into the key point detection model generated in embodiment 1, and the key point detection model performs human body key point detection and acquires the coordinate information and the field-of-view probabilities of one or more human body key points, wherein the field-of-view probability is the probability that the human body key point appears in the imaging field of view of the target image frame.

In some embodiments, the coordinate information is expressed as (uₙ, vₙ, depthₙ), and the coordinate information output by the key point detection model costs less compared to the 3D coordinate information output by the 3D posture network. This is because some of the information in the 3D coordinate information is not required, and the virtual drive scene does not require the possible depth value of the actual scene but only requires a relative value. Therefore, the 3D coordinate information is converted into pseudo-3D coordinate information in the image coordinate scale by the training scheme of embodiment 1.

In some embodiments, upon acquiring the coordinate information and the field-of-view probabilities of the human body key points of the target image frame, the method further includes the following processes:
determining a smoothing weight between a current target image frame and a previous target image frame; and smoothing the coordinate information and the field-of-view probability using the smoothing weight.

In some embodiments, in a scene of virtual live broadcasting with a cell phone, the key points of the human body outside the field of view are paid less attention, and it is sufficient to make these key points as smooth as possible without jumps and obvious errors. Therefore, the coordinate information and the prediction probability are smoothed by a filter in some embodiments.

In some embodiments, the above process of determining the smoothing weight between the current target image frame and the previous target image frame includes the following processes:
for each human body key point of the plurality of human body key points, determining a distance between coordinate information of the human body key point in the current target image frame and smoothed coordinate information of the human body key point in the previous target image frame; comparing the distance with a predetermined distance, and determining a distance weight based on the comparison result; and calculating the smoothing weight using distance weights and field-of-view probabilities of the human body key points in the current target image frame.

In some embodiments, for a human body key point, upon acquiring the smoothed coordinate information of the human body key point in the previous target image frame and the coordinate information of the human body key point in the current target image frame, the distance between the two coordinate information is calculated using a distance calculation formula. In some embodiments, the distance is calculated using the following formula:

$${distance}^{n} = {‖ {J}_{3 d}^{n} - {Cached\_J}_{3 d}^{n - 1} ‖}_{2} .$$

wherein distanceⁿ represents the distance between the coordinate information of the n^{th} human body key point in the current target image frame and the smoothed coordinate information of the n^{th} human body key point in the previous target image frame,

$${J}_{3 d}^{n}$$

represents the coordinate information of the n^{th} human body key point in the current target image frame, and Cached

$${J}_{3 d}^{n - 1}$$

represents the smoothed coordinate information of the n^{th} human body key point in the previous target image frame.

In some embodiments, comparing the distance acquired above with the predetermined distance is achieved by calculating a ratio of the two distances, that is, the comparison result is the ratio of the two distances, i.e.,

$$\frac{{distance}^{n}}{threshold} ,$$

wherein threshold represents the predetermined distance. In the case that the distance distanceⁿ is lower than the threshold, the cached history data has a larger weight and the current key point has a small weight; and in the case that the distance distanceⁿ is greater than the threshold, the history data has a smaller weight and the current key point has a larger weight.

In some embodiments, the distance weight is calculated using the following formula:

$$distance weight = \frac{1}{1 + {e}^{k * ( 1 - \frac{{distance}^{n}}{threshold} )}} ,$$

wherein k represents the predetermined intensity of smoothing. The larger the k, the smaller the window, and the stronger the ability to suppress drastic jumps.

In the case that the distance weight is acquired, the smoothing weight is calculated by combining the distance weight with the field-of-view probability of the current human key point in the current target image frame. In some embodiments, the smoothing weight is calculated using the following formula:

$$smoothing weight {ratio}^{n} = 1 - distance weight * field - of - view probability = 1 - \frac{1}{1 + {e}^{k * ( 1 - \frac{{distance}^{n}}{threshold} )}} * {prob}^{n} ,$$

wherein probⁿ represents the field-of-view probability of the n^{th} human body key point.

In the case that the smoothing weight is acquired, the smoothing weight is used to smooth the coordinate information and the field-of-view probability. In some embodiments, the smoothing includes the following processes:
determining, based on the smoothing weight, a first weight of the previous target image frame and a second weight of the current target image frame; acquiring smoothed coordinate information by performing, based on the first weight and the second weight, weighted calculation on coordinate information of the previous target image frame and coordinate information of the current target image frame; and acquiring a smoothed field-of-view probability by performing, based on the first weight and the second weight, weighted calculation on a field-of-view probability of the previous target image frame and a field-of-view probability of the current target image frame.

In some embodiments, assuming that the first weight is the smoothing weight, the second weight is the difference between the value 1 and the smoothing weight, i.e., the first weight=ratioⁿ and the second weight=1−ratioⁿ.

The process of smoothing for the coordinate information is shown by the following formula:

$${Cached\_J}_{3 d}^{n} = {ratio}^{n} * {Cached\_J}_{3 d}^{n - 1} + ( 1 - {ratio}^{n} ) {J}_{3 d}^{n} .$$

The process of smoothing the field-of-view probability is shown by the following formula:

$${Cached\_prob}^{n} = {ratio}^{n} * {Cached\_prob}^{n - 1} - + ( 1 - {ratio}^{n} ) {prob}^{n} ,$$

wherein Cached_probⁿ represents the smoothed field-of-view probability, and Cached_probⁿ⁻¹ represents the previously smoothed field-of-view probability.

In the embodiments, a filter is introduced to smooth the jumps of the key point and the changes of states of the key point within or outside the field of view, and by decreasing the drastic jumps of the coordinates of the key point and lowering the weight of the current frame in the case of the key point being outside the field of view, the output result of the human body key points is generally ensured to be relatively stable and continuous.

In process 203, a corresponding virtual character is driven to act based on the coordinate information and the field-of-view probability of the human body key point.

In some embodiments, in the case that the final coordinate information and the field-of-view probability of the human body key points of the target image frame are acquired, it is determined, based on the field-of-view probability, whether the corresponding human body key point is within the field of view of the target image frame. In the case that the key point is within the field of view, the corresponding human body part of the virtual character is driven, based on the coordinate information, to move to the position corresponding to the coordinate information; and in the case that the key point is outside of the field of view, the virtual character makes no action.

In some embodiments, these human body key points make the interaction between the anchor and the user richer, such as waving a hand, making a finger heart, displaying a 3D gift from the user on the arm or wrist of the 3D character, or allowing the anchor and the user's virtual character to play an interactive game in the virtual 3D space.

In the embodiments, the key point detection model detects the coordinate information and the field-of-view probability of the human body key point of the target image frame, the field-of-view probability being the probability of the human body key point appearing in the imaging field of view of the target image frame, and the corresponding virtual character is driven to act by combining the field-of-view probability and the coordinate information. In this way, the signal output of the human body key point from end to end is achieved, and in the case of a close-up view, the stability of the human body key point is ensured to some extent, and the driving requirements for the virtual character on the mobile phone are met.

### Embodiment 3

FIG. 5 is a structural schematic diagram of an apparatus for training a key point detection model according to embodiment 3 of the present disclosure. The apparatus includes the following modules: a key point detecting module 301, configured to determine coordinate information of a plurality of key points in each sample image frame of a plurality of sample image frames in a sample set by performing key point detection on the plurality of sample image frames; a field-of-view label determining module 302, configured to determine a field-of-view label of each key point of the plurality of key points based on coordinate information of the key point, the field-of-view label being configured to mark whether the key point is within the imaging field of view of a sample image frame to which the key point belongs; a model training module 303, configured to train the key point detection model by taking coordinate information and field-of-view labels of a plurality of key points of the plurality of sample image frames as a supervision signal, the key point detection model being configured to perform key point detection on a target image frame in a model inference stage and output coordinate information and a field-of-view probability of a key point in the target image frame.

In some embodiments, the key point detecting module 301 includes the following modules: a two-dimensional posture predicting module, configured to input the plurality of sample image frames into a pre-generated two-dimensional posture network, and acquire two-dimensional coordinate information of key points of the plurality of sample image frames from the two-dimensional posture network; a three-dimensional posture predicting module, configured to input the plurality of sample image frames into a pre-generated three-dimensional posture network, and acquire three-dimensional coordinate information of the key points of the plurality of sample image frames from the three-dimensional posture network; and a coordinate determining module, configured to determine coordinate information of each of the key points based on the acquired two-dimensional coordinate information and the three-dimensional coordinate information of the key points.

In some embodiments, the two-dimensional coordinate information comprises a horizontal coordinate value and a vertical coordinate value, and the three-dimensional coordinate information comprises an X-axis coordinate value, a Y-axis coordinate value, and a Z-axis coordinate value; and the coordinate determining module includes the following modules: a stable key point determining module, configured to determine a first stable key point and a second stable key point from the plurality of key points of the plurality of sample image frames; an adjustment coefficient determining module, configured to determine an adjustment coefficient based on two-dimensional coordinate information and three-dimensional coordinate information of the first stable key point and two-dimensional coordinate information and three-dimensional coordinate information of the second stable key point; an adjusting module, configured to acquire a depth value of each of the key points by adjusting, using the adjustment coefficient, Z-axis coordinate values of the plurality of key points of the plurality of sample image frames; and a coordinate generating module, configured to determine a horizontal coordinate value, a vertical coordinate value, and the depth value of each of the key points as coordinate information of the key point.

In some embodiments, the adjustment coefficient determining module is configured to: determine an absolute value of a difference between the two-dimensional coordinate information of the first stable key point and the two-dimensional coordinate information of the second stable key point as a first difference; determine an absolute value of a difference between the three-dimensional coordinate information of the first stable key point and the three-dimensional coordinate information of the second stable key point as a second difference; and determine a ratio of the first difference to the second difference as the adjustment coefficient.

In some embodiments, the coordinate information comprises a horizontal coordinate value and a vertical coordinate value, and the field-of-view label comprises an in-field-of-view label and an out-of-field-of-view label; and
the field-of-view label determining module 302 is configured to: acquire a width and a height of each sample image frame; determine, by taking an origin of an image coordinate system as a starting point, a horizontal coordinate range based on widths of the plurality of sample image frames and a vertical coordinate range based on heights of the plurality of sample image frames; determine, in response to a horizontal coordinate value of each key point being within the horizontal coordinate range, or, a vertical coordinate value of each key point being within the vertical coordinate range, the field-of-view label of the key point to be an in-field-of-view label; and determine, in response to the horizontal coordinate value of each key point being out of the horizontal coordinate range and the vertical coordinate value of each key point being out of the vertical coordinate range, the field-of-view label of the key point to be an out-of-field-of-view label.

In some embodiments, the apparatus further includes the following module: an image augmenting module, configured to: upon determining the coordinate information of the plurality of key points in each sample image frame, perform image augmentation on the plurality of sample image frames based on the coordinate information in each sample image frame, the image augmentation including at least one of: random perturbation, cropping, or combination thereof.

In some embodiments, the image augmenting module is configured to: determine a center position of a cropping frame based on the coordinate information of the plurality of key points in each sample image frame; and determine a cropping frame position based on the center position of the cropping frame, and set, based on the cropping frame position, RGB values of a pixel point outside the cropping frame to make the pixel point black.

In some embodiments, the loss function used in training the key point detection model includes a heatmap loss function, a location loss function, and a label loss function.

The apparatus for training a key point detection model according to the embodiments of the present disclosure is applicable to performing the method for training a key point detection model according to the embodiment 1 of the present disclosure and has corresponding functional modules for performing the method.

### Embodiment 4

FIG. 6 is a structural schematic diagram of an apparatus for driving a virtual character according to embodiments 4 of the present disclosure. The apparatus includes the following modules: an image acquiring module 401, configured to acquire a target image frame, the target image frame comprising an image of a part of a human body; a human body key point detecting module 402, configured to input the target image frame into a pre-trained key point detection model, and acquire coordinate information and a field-of-view probability of a human body key point of the target image frame output by the key point detection model, the field-of-view probability being a probability that the human body key point appears within an imaging field of view of the target image frame; a virtual character driving module 403, configured to drive a corresponding virtual character to act based on the coordinate information and the field-of-view probability of the human body key point.

In some embodiments, the apparatus further includes the following modules: a smoothing weight determining module, configured to determine a smoothing weight between a current target image frame and a previous target image frame; a smoothing module, configured to smoothing the coordinate information and the field-of-view probability using the smoothing weight.

In some embodiments, the smoothing weight determining module is configured to: for each human body key point, determine a distance between coordinate information of the human body key point in the current target image frame and smoothed coordinate information of the human body key point in the previous target image frame; compare the distance with a predetermined distance, and determine a distance weight based on the comparison result; and calculate the smoothing weight using distance weights and field-of-view probabilities of the human body key points in the current target image frame.

In some embodiments, the smoothing module is configured to: determine, based on the smoothing weight, a first weight of the previous target image frame and a second weight of the current target image frame; acquire smoothed coordinate information by performing, based on the first weight and the second weight, weighted calculation on coordinate information of the previous target image frame and coordinate information of the current target image frame; and acquire a smoothed field-of-view probability by performing, based on the first weight and the second weight, weighted calculation on a field-of-view probability of the previous target image frame and a field-of-view probability of the current target image frame.

The apparatus for driving a virtual character according to the embodiments of the present disclosure is applicable to performing the method for driving a virtual character according to embodiment 2 of the present disclosure and has corresponding functional modules to perform the method.

### Embodiment 5

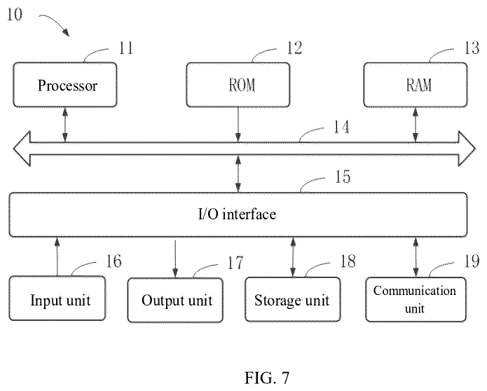

FIG. 7 is a structural schematic diagram of an electronic device 10 applicable to performing the method embodiments of the present disclosure. As shown in FIG. 7, the electronic device 10 is a device such as a server, a cellular phone, etc., including one or more processors 11 and a storage device that is communicatively connected to the one or more processors 11. The storage device includes a read-only memory (ROM) 12, a random access memory (RAM) 13, etc. The storage device stores one or more computer programs executable by the one or more processors, and in some embodiments, the one or more processors 11 performs a variety of appropriate operations and processes based on the one or more computer programs stored in the ROM 12 or loaded into the RAM 13 from the storage unit 18. In some embodiments, a plurality of programs and data required for the operation of electronic device 10 are stored in the RAM 13.

In some embodiments, the method according to embodiment 1 or embodiment 2 is implemented as one or more computer programs that are tangibly contained in a computer-readable storage medium, such as storage unit 18. In some embodiments, some or all of the computer programs are loaded and/or installed onto electronic device 10 via the ROM 12 and/or a communication unit 19. The one or more computer programs, when loaded into the RAM 13 and run by the one or more processors 11, cause the one or more processors to perform one or more processes of the method according to embodiment 1 or embodiment 2 described above.

In some embodiments, the method according to embodiment 1 or embodiment 2 is implemented as a computer program product including one or more computer-executable instructions. The one or more computer-executable instructions, when run by a processor of a device, cause the device to perform one or more processes of the method according to embodiment 1 or embodiment 2 described above.

1. A method for driving a virtual character, comprising:
acquiring a target image frame, the target image frame comprising an image of a part of a human body;
inputting the target image frame into a pre-trained key point detection model, and acquiring coordinate information and a field-of-view probability of a human body key point of the target image frame output by the key point detection model, the field-of-view probability being a probability that the human body key point appears within an imaging field of view of the target image frame; and
driving, based on the coordinate information and the field-of-view probability of the human body key point, a corresponding virtual character to act.

2. The method according to claim 1, wherein prior to driving, based on the coordinate information and the field-of-view probability of the human body key point, the corresponding virtual character to act, the method further comprises:
determining a smoothing weight between a current target image frame and a previous target image frame; and
smoothing the coordinate information and the field-of-view probability using the smoothing weight.

3. The method according to claim 2, wherein determining the smoothing weight between the current target image frame and the previous target image frame comprises:
determining a distance between coordinate information of each human body key point of a plurality of human body key points in the current target image frame and smoothed coordinate information of the human body key point in the previous target image frame;
comparing the distance with a predetermined distance, and determining a distance weight based on the comparison result; and
calculating the smoothing weight using distance weights of the plurality of human body key points and field-of-view probabilities of the plurality of human body key points in the current target image frame.

4. The method according to claim 2, wherein smoothing the coordinate information and the field-of-view probability using the smoothing weight comprises:
determining, based on the smoothing weight, a first weight of the previous target image frame and a second weight of the current target image frame;
acquiring smoothed coordinate information by performing, based on the first weight and the second weight, weighted calculation on coordinate information of the previous target image frame and coordinate information of the current target image frame; and
acquiring a smoothed field-of-view probability by performing, based on the first weight and the second weight, weighted calculation on a field-of-view probability of the previous target image frame and a field-of-view probability of the current target image frame.

5. A method for training a key point detection model, comprising:
determining coordinate information of a plurality of key points in each sample image frame of a plurality of sample image frames in a sample set by performing key point detection on the plurality of sample image frames;
determining a field-of-view label of each key point of the plurality of key points based on coordinate information of the key point, the field-of-view label being configured to mark whether the key point is within the imaging field of view of a sample image frame to which the key point belongs; and
training the key point detection model by taking coordinate information and field-of-view labels of a plurality of key points of the plurality of sample image frames as a supervision signal, the key point detection model being configured to perform key point detection on a target image frame in a model inference stage and output coordinate information and a field-of-view probability of a key point in the target image frame.

6. The method according to claim 5, wherein determining the coordinate information of the plurality of key points in each sample image frame of the plurality of sample image frames in the sample set by performing key point detection on the plurality of sample image frames comprises:
inputting the plurality of sample image frames into a pre-generated two-dimensional posture network, and acquiring two-dimensional coordinate information of key points of the plurality of sample image frames from the two-dimensional posture network;
inputting the plurality of sample image frames into a pre-generated three-dimensional posture network, and acquiring three-dimensional coordinate information of the key points of the plurality of sample image frames from the three-dimensional posture network; and
determining coordinate information of each of the key points based on the acquired two-dimensional coordinate information and the three-dimensional coordinate information of the key points.

7. The method according to claim 6, wherein
the two-dimensional coordinate information comprises a horizontal coordinate value and a vertical coordinate value, and the three-dimensional coordinate information comprises an X-axis coordinate value, a Y-axis coordinate value, and a Z-axis coordinate value; and
determining the coordinate information of each of the key points based on the acquired two-dimensional coordinate information and the three-dimensional coordinate information of the key points comprises:
determining a first stable key point and a second stable key point from the plurality of key points of the plurality of sample image frames;
determining an adjustment coefficient based on two-dimensional coordinate information and three-dimensional coordinate information of the first stable key point and two-dimensional coordinate information and three-dimensional coordinate information of the second stable key point;
acquiring a depth value of each of the key points by adjusting, using the adjustment coefficient, Z-axis coordinate values of the plurality of key points of the plurality of sample image frames; and
determining a horizontal coordinate value, a vertical coordinate value, and the depth value of each of the key points as coordinate information of the key point.

8. The method according to claim 7, wherein determining the adjustment coefficient based on the two-dimensional coordinate information and the three-dimensional coordinate information of the first stable key point and the two-dimensional coordinate information and the three-dimensional coordinate information of the second stable key point comprises:
determining an absolute value of a difference between the two-dimensional coordinate information of the first stable key point and the two-dimensional coordinate information of the second stable key point as a first difference;
determining an absolute value of a difference between the three-dimensional coordinate information of the first stable key point and the three-dimensional coordinate information of the second stable key point as a second difference; and
determining a ratio of the first difference to the second difference as the adjustment coefficient.

9. The method according to claim 5, wherein
the coordinate information comprises a horizontal coordinate value and a vertical coordinate value, and the field-of-view label comprises an in-field-of-view label and an out-of-field-of-view label; and
determining the field-of-view label of each key point of the plurality of key points based on the coordinate information of the key point comprises:
acquiring a width and a height of each sample image frame;
determining, by taking an origin of an image coordinate system as a starting point, a horizontal coordinate range based on widths of the plurality of sample image frames and a vertical coordinate range based on heights of the plurality of sample image frames;
determining, in response to a horizontal coordinate value of each key point being within the horizontal coordinate range or a vertical coordinate value of each key point being within the vertical coordinate range, the field-of-view label of the key point to be an in-field-of-view label; and
determining, in response to the horizontal coordinate value of each key point being out of the horizontal coordinate range and the vertical coordinate value of each key point being out of the vertical coordinate range, the field-of-view label of the key point to be an out-of-field-of-view label.

10. The method according to claim 5, wherein upon determining the coordinate information of the plurality of key points in each sample image frame, the method further comprises:
performing image augmentation on the plurality of sample image frames based on the coordinate information of the plurality of key points in each sample image frame, the image augmentation comprising at least one of: random perturbation or cropping.

11. The method according to claim 10, wherein in a case where the image augmentation comprises the cropping, the cropping comprises:
determining a center position of a cropping frame based on the coordinate information of the plurality of key points in each sample image frame; and
determining a cropping frame position based on the center position of the cropping frame, and setting, based on the cropping frame position, RGB values of a pixel point outside the cropping frame to make the pixel point black.

12-13. (canceled)

14. An electronic device, comprising:
one or more processors; and
a storage device, configured to store one or more programs;
wherein the one or more programs, when loaded and run by the one or more processors, cause the one or more processors to:
acquire a target image frame, the target image frame comprising an image of a part of a human body;
input the target image frame into a pre-trained key point detection model, and acquire coordinate information and a field-of-view probability of a human body key point of the target image frame output by the key point detection model, the field-of-view probability being a probability that the human body key point appears within an imaging field of view of the target image frame; and
drive, based on the coordinate information and the field-of-view probability of the human body key point, a corresponding virtual character to act; or
wherein the one or more programs, when loaded and run by the one or more processors, cause the one or more processors to:
determine coordinate information of a plurality of key points in each sample image frame of a plurality of sample image frames in a sample set by performing key point detection on the plurality of sample image frames;
determine a field-of-view label of each key point of the plurality of key points based on coordinate information of the key point, the field-of-view label being configured to mark whether the key point is within the imaging field of view of a sample image frame to which the key point belongs; and
train a key point detection model by taking coordinate information and field-of-view labels of a plurality of key points of the plurality of sample image frames as a supervision signal, the key point detection model being configured to perform key point detection on a target image frame in a model inference stage and output coordinate information and a field-of-view probability of a key point in the target image frame.

15. A non-transitory computer-readable storage medium, storing one or more computer programs thereon, wherein the one or more programs, when run by a processor, cause the processor to perform the method as defined in claim 1 or perform:
determining coordinate information of a plurality of key points in each sample image frame of a plurality of sample image frames in a sample set by performing key point detection on the plurality of sample image frames;
determining a field-of-view label of each key point of the plurality of key points based on coordinate information of the key point, the field-of-view label being configured to mark whether the key point is within the imaging field of view of a sample image frame to which the key point belongs; and
training a key point detection model by taking coordinate information and field-of-view labels of a plurality of key points of the plurality of sample image frames as a supervision signal, the key point detection model being configured to perform key point detection on a target image frame in a model inference stage and output coordinate information and a field-of-view probability of a key point in the target image frame.

16. A computer program product, comprising one or more computer-executable instructions, wherein the one or more computer-executable instructions, when run by a processor of a device, cause the device to perform the method as defined in claim 1 or perform:
determining coordinate information of a plurality of key points in each sample image frame of a plurality of sample image frames in a sample set by performing key point detection on the plurality of sample image frames;
determining a field-of-view label of each key point of the plurality of key points based on coordinate information of the key point, the field-of-view label being configured to mark whether the key point is within the imaging field of view of a sample image frame to which the key point belongs; and
training a key point detection model by taking coordinate information and field-of-view labels of a plurality of key points of the plurality of sample image frames as a supervision signal, the key point detection model being configured to perform key point detection on a target image frame in a model inference stage and output coordinate information and a field-of-view probability of a key point in the target image frame.

17. The electronic device according to claim 14, wherein the one or more programs, when loaded and run by the one or more processors, cause the one or more processors to:
determine a smoothing weight between a current target image frame and a previous target image frame; and
smooth the coordinate information and the field-of-view probability using the smoothing weight.

18. The electronic device according to claim 17, wherein the one or more programs, when loaded and run by the one or more processors, cause the one or more processors to:
determine a distance between coordinate information of each human body key point of a plurality of human body key points in the current target image frame and smoothed coordinate information of the human body key point in the previous target image frame;
compare the distance with a predetermined distance, and determine a distance weight based on the comparison result; and
calculate the smoothing weight using distance weights of the plurality of human body key points and field-of-view probabilities of the plurality of human body key points in the current target image frame.

19. The electronic device according to claim 17, wherein the one or more programs, when loaded and run by the one or more processors, cause the one or more processors to:
determine, based on the smoothing weight, a first weight of the previous target image frame and a second weight of the current target image frame;
acquire smoothed coordinate information by performing, based on the first weight and the second weight, weighted calculation on coordinate information of the previous target image frame and coordinate information of the current target image frame; and
acquire a smoothed field-of-view probability by performing, based on the first weight and the second weight, weighted calculation on a field-of-view probability of the previous target image frame and a field-of-view probability of the current target image frame.

20. The electronic device according to claim 14, wherein the one or more programs, when loaded and run by the one or more processors, cause the one or more processors to:
input the plurality of sample image frames into a pre-generated two-dimensional posture network, and acquire two-dimensional coordinate information of key points of the plurality of sample image frames from the two-dimensional posture network;
input the plurality of sample image frames into a pre-generated three-dimensional posture network, and acquire three-dimensional coordinate information of the key points of the plurality of sample image frames from the three-dimensional posture network; and
determine coordinate information of each of the key points based on the acquired two-dimensional coordinate information and the three-dimensional coordinate information of the key points.

21. The electronic device according to claim 20, wherein the one or more programs, when loaded and run by the one or more processors, cause the one or more processors to:
determine a first stable key point and a second stable key point from the plurality of key points of the plurality of sample image frames;
determine an adjustment coefficient based on two-dimensional coordinate information and three-dimensional coordinate information of the first stable key point and two-dimensional coordinate information and three-dimensional coordinate information of the second stable key point;
acquire a depth value of each of the key points by adjusting, using the adjustment coefficient, Z-axis coordinate values of the plurality of key points of the plurality of sample image frames; and
determine a horizontal coordinate value, a vertical coordinate value, and the depth value of each of the key points as coordinate information of the key point.

22. The electronic device according to claim 21, wherein the one or more programs, when loaded and run by the one or more processors, cause the one or more processors to:
determine an absolute value of a difference between the two-dimensional coordinate information of the first stable key point and the two-dimensional coordinate information of the second stable key point as a first difference;
determine an absolute value of a difference between the three-dimensional coordinate information of the first stable key point and the three-dimensional coordinate information of the second stable key point as a second difference; and
determine a ratio of the first difference to the second difference as the adjustment coefficient.
